(19) United States
(12) Patent Application Publication
(10) Pub. No.: US 2008/0012310 A1
(43) Pub. Date: Jan. 17, 2008

(54) Automatic self-centering duct robot

(76) Inventors: Lance Weaver, Rapid City, SD (US); Bernt Askildsen, Rapid City, SD (US)

Correspondence Address: Gene R. Woodle, 3516 Woodle Dr., Rapid City, SD, 57702, US

(21) Appl. No.: 11/823,929

(22) Filed: Jun. 30, 2007

Related U.S. Application Data
(60) Provisional application No. 60/806,463, filed on Jul. 1, 2006.

(51) Int. Cl. F16L 13/02

(52) U.S. Cl. 285/288.1

(57) ABSTRACT

Embodiments of an automatic self-centering duct robot are disclosed which may be used as a tool platform for cleaning and maintenance of HVAC conduits and ducts. The robot includes sensors and a control system such that it is self-centering and automatically moves along the centerline of a conduit or duct.

### RELATED APPLICATIONS

This application relies for priority upon the Provisional Patent Application filed by Lance Weaver and Bernt Askildsen entitled Automatic Self-Centering Conduit Robot Apparatus, Ser. No. 60/806,463, filed Jul. 1, 2006.

### BACKGROUND OF THE INVENTION

1. Field of the Invention

The present invention relates generally to cleaning and maintenance of heating, ventilation and air conditioning (HVAC) ductwork and more specifically to an automatic self-centering duct robot which may be used to clean and maintain HVAC ducts.

2. Background Information

There are many miles of HVAC ducts and conduits in residential and commercial buildings around the world. These conduits and ducts require regular cleaning and maintenance to insure good indoor air quality and to provide for good energy efficiency. In some parts of the United States HVAC efficiency is mandated by law. For example, Title 24 of the California Building Code limits the allowed air leakage from HVAC conduits and ducts.

HVAC conduits and ducts have a variety of designs and may have a wide range of dimensions. Such ducts also come in a wide variety of cross sections including circular, square, and rectangular. A number of different processes are usually necessary to keep these ducts clean and well maintained. Some of these processes include: cleaning, applying a coating to the inside of the duct, disinfecting the duct, sealing the duct, and making repairs on the duct. In some instances these processes are performed by cutting a number of holes in the duct and performing the process by hand. Recently, a number of these processes are being accomplished by use of a robot which may be inserted into the duct and operated by remote control. When a remote control robot is used for the various duct maintenance processes, for obvious reasons, it is necessary for an operator to be able to locate the robot both relative to the longitudinal axis of the duct and relative to the sides of the duct.

A number of inventions have been patented which attempt to solve problems relating to locating similar devices or performing similar processes inside an enclosed article. The patent to Ryan (U.S. Pat. No. 3,800,358; Apr. 2, 1974) discloses a remote-controlled self-propelled duct cleaning robot for rectangular ducts and the patent to Loomer (U.S. Pat. No. 3,973,685; Aug. 10, 1976) discloses the use of photoelectric sensing for a pallet carrying robot vehicle. Another patent to Carter Jr. et al. (U.S. Pat. No. 4,309,618; Jan. 5, 1982) discloses a method for precision distance or displacement measurements using a light source and a detector. The patent to Weber et al. (U.S. Pat. No. 4,473,921; Oct. 2, 1984) discloses a cleaning device for the internal peripheral surfaces of pipelines or hollow cylindrical vessels and the patent to White et al. (U.S. Pat. No. 4,736,826; Apr. 12, 1988) discloses a mobile robot remotely controlled or powered through a cable from a stationary console.

The automatic self-centering duct robot of the instant invention solves a number of problems relating to the use of a robot for cleaning or maintenance of HVAC ducts or conduits in a unique and original manner not exhibited in the prior art. The automatic self-centering duct robot of the instant invention can sense lateral wall distances to align itself parallel to the sidewalls and centered within the sidewalls. This significantly improves the ability of the device to clean, coat, disinfect, seal, and repair ducts and conduits of different shapes and dimensions as it enables the vehicle to drive in straight lines down the center of the duct or conduit.

The ideal automatic self-centering duct robot should have the ability to be maneuvered easily through any shape or type of HVAC duct or conduit. The ideal automatic self-centering duct robot should be capable of sensing its position within a duct or conduit and be capable of being maneuvered through the duct or conduit along the centerline of the duct or conduit. The ideal automatic self-centering duct robot should also be simple, reliable, inexpensive, and easy to use.

### SUMMARY OF THE INVENTION

The automatic self-centering duct robot of the instant invention may be used to easily and efficiently to clean, coat, disinfect, seal, and repair HVAC conduits and ducts. The device includes a platform with four wheels which rotate independently. Electric motors power the left front and right rear wheels independently such that the robot can be controlled to move in any direction or to rotate up to 360 degrees without moving. Four distance sensors are affixed to the platform such that they are at ninety degree angles to each other and at forty-five degree angles to the longitudinal axis of the platform.

Each of the four distance sensors are capable of being used to measure the distance between the sensor and a wall of the duct or conduit. Signals from each distance sensor are transmitted to a microcontroller which automatically uses the four distance measurements to calculate the distance between the robot and the two side walls of the duct or conduit. The microcontroller also controls the two drive wheel motors, and, using the distance calculations based on signals from the distance sensors, controls the motors to cause the robot to move along the centerline of the duct or conduit.

Although not considered a part of this invention, various attachments could be removably affixed to the automatic self-centering duct robot of the instant invention to clean, coat, disinfect, seal, and repair HVAC conduits and ducts.

The above describes the basic configuration of the automatic self-centering duct robot of he instant invention. Although the device is described as being used to clean and maintain HVAC ducts and conduits, it will be understood that the device could also be used for any number of other, similar, purposes.

One of the major objects of the present invention is to provide an automatic self-centering duct robot which may be maneuvered easily through any shape or type of HVAC duct or conduit.

Another objective of the present invention is to provide a robot which is capable of sensing its position within a duct or conduit and capable of being maneuvered through the duct or conduit along the centerline of the duct or conduit.

Another objective of the present invention is to provide a automatic self-centering duct robot which is simple, reliable, inexpensive, and easy to use.

These and other features of the invention will become apparent when taken in consideration with the following detailed description and the drawings.

### BRIEF DESCRIPTION OF THE DRAWINGS

FIG. 1 is a top view of the automatic self-centering duct robot of the instant invention within a duct or conduit;

FIG. 2 is a schematic diagram of the control system of the automatic self-centering duct robot of the instant invention;

FIG. 3 is a top view of a second embodiment of the automatic self-centering duct robot of the instant invention; and

FIG. 4 is an isometric view of the self-centering duct robot of the instant invention within a duct.

### DESCRIPTION OF A PREFERRED EMBODIMENT

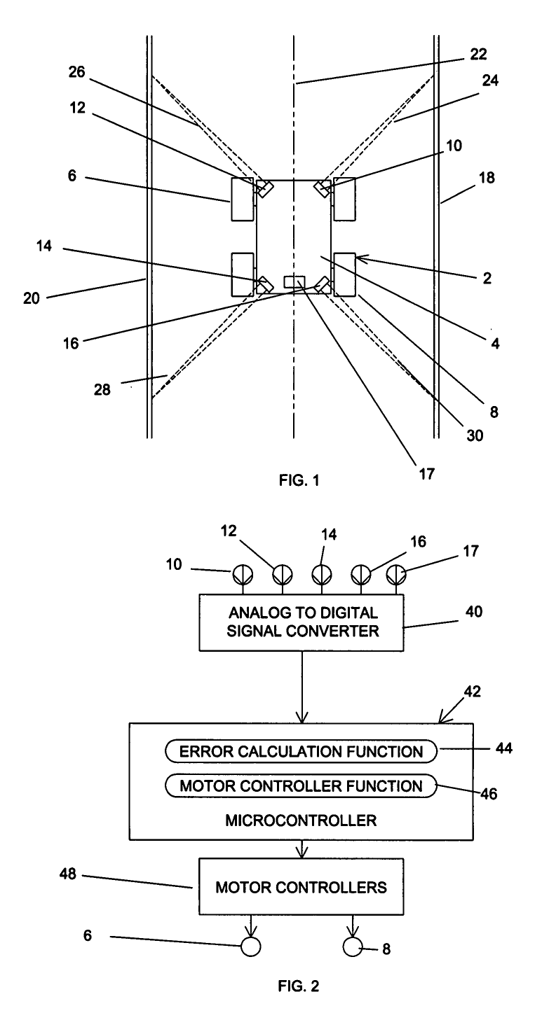

Referring to the drawings, FIGS. 1 through 4, there is shown the preferred embodiment of the automatic self-centering duct robot of the instant invention. The instant invention is shown and described below as a device to be used to clean and maintain HVAC ducts and conduits, but, without changing the spirit of the invention, the device could be used for a wide variety of other purposes.

Now referring to FIG. 1, a top view of the automatic self-centering duct robot of the instant invention within a duct is shown. For description purposes, the top of the figure is considered to be forward. The robot 2 includes a platform 4 which has four wheels, one affixed near each corner of the platform 4. A front drive wheel 6 is affixed to the left front of said platform 4 and a rear drive wheel 8 is affixed to the right rear of said platform 4. Both the front drive wheel 6 and the rear drive wheel 8 are powered by conventional electric motors (not shown). The other two wheels are not powered. The electric motors are capable of being turned at a variety of speeds and in either direction. As will be easily understood, by controlling the electric motors and the speed and direction of rotation of said front drive wheel 6 and said drive wheel 8, the robot 2 can be moved in any direction and even rotated without moving. Although the device is described as having powered wheels at the left front and the right rear, the device could be configured to work properly as long as any two wheels are independently controlled. Although the device is described as having wheels driven by electric motors, any of a number of other means of propulsion belts, tracks, legs, or fins could be used.

Still referring to FIG. 1, four distance sensors are affixed at the comers of said platform 4. Sensor 10 is located at the right front corner, sensor 12 is located at the left front corner, sensor 14 is located at the left rear corner, and sensor 16 is located at the right rear corner. The sensors are conventional infrared sensors, but any of a variety of other types of conventional sensors including cameras with sensors could be used. Said robot 2 is located within a duct or conduit and the right side of the duct is shown as right duct side 18 and the left side of the duct is shown as left duct side 20. With the longitudinal axis of said platform 4 parallel to right duct side 18 and left duct side 20 as shown, sensor 10 points forward and right at forty-five degrees to a centerline 22 through the center of the duct. Sensor 12 points forward and left at forty-five degrees to the centerline 22, sensor 14 points rearward and left at forty-five degrees to said centerline 22, and sensor 16 points rearward and right at forty-five degrees to said centerline 22. Thus, all these sensors are directed at forty-five degrees from the longitudinal axis of said platform 4 and ninety degrees to each other. In addition to the four sensors described above, there is a sensor 17 located on the top surface of said platform 4 which is directed upward. The sensor 17 measures the distance between the top surface of said platform 4 and the bottom surface of the top of the duct or conduit. By using said sensor 17 in combination with the other four sensors, any movable attachment to said robot 2 could be located and controlled in three dimensions.

Still referring to FIG. 1, the sensors paths are shown as path 24 for said sensor 10, path 26 for said sensor 12, path 28 for said sensor 14, and path 30 for said sensor 16. Sensor 10, for example, sends an infrared signal along path 24 which hits said right duct side 18 and returns. Said sensor 10 determines the time it takes for the signal to reach said right duct side 18 and return and, thus, is capable of determining the distance of said path 24. Similarly, the other sensors determine the distances of said paths 26, 28, and 30. As, for example, the length of path 24 is known and as a line from said sensor 10 and said right duct side 18 which is at a right angle to said right duct side 18 can be used to determine the distance of said robot 2 from said right duct side 18, the Pythagorean theorem may be used to easily determine the distance from said sensor 10 to said right duct side 18. In actual practice, said robot 2 can be moved forward along said centerline 22 by subtracting the distance of said path 24 from said path 26 and controlling the electric motors on said front drive wheel 6 and said rear drive wheel 8 such that the difference approaches zero. The simple formula: rate times time equal distance is used remembering that the distance traveled along, for example, said path 24 is double the actual distance between said sensor 10 and said right duct side 18 because said path 24 is actually from said sensor 10 to said right duct side 18 and back to said sensor 10. The same process may be used when said robot 2 is operated in reverse by subtracting the distance of said path 28 from said path 30. Of course other formulas and calculations could be used.

Referring now to FIG. 2, a schematic diagram of the control system of the automatic self-centering duct robot of the instant invention is shown. A conventional analog to digital converter 40 receives the signals from said sensors 10, 12, 14, 16, and 17 and converts the analog signals from the sensors into digital data. A conventional microcontroller 42 includes an error calculation function 44 and a motor controller function 46. The error calculation function 44 calculates either the difference between the distance measured by said sensors 10 and 12 for forward motion or the difference between the distance measured by said sensors 14 and 16 for rearward motion of said robot 2. The motor controller function 46 uses input from said error calculation function 44 to cause the difference between the distance between said robot 2 and said left duct side 20 and said right duct side 18 to approach zero by controlling the motor drivers 48. The motor drivers 48 control the speed of the electric motors driving said front drive wheel 6 and said rear drive wheel 8. The above described self-centering capability of said robot 2 may be activated by powering up the infrared sensors remotely or manually before said robot 2 is inserted into the duct. The input from said sensor 17 may be used in conjunction with the other four sensors to locate and control any movable attachment to said robot 2 in three dimensions.

Still referring to FIG. 2, the analog to digital converter 40 may be integrated into said microcontroller 42. In the preferred embodiment, a conventional proportional-integral-derivative controller (PID controller) is used. However, a simpler controller could be used, because the integral and derivative functions of a standard PID controller are not used for this application. Other, advanced, control systems such as Fuzzy logic, an artificial neural network, expert systems, or some combination of them could also be used. It will be understood that it would be relatively simple to program the instant invention such that said robot 2 travels along a line in either direction which is offset by a specified distance from said centerline 22. For example, if it were desired to offset by 10 centimeters to the left of said centerline 22, the error is calculated using this offset by adding it to the measurement from said sensor 12 and said sensor 14 measurement before subtracting. In summary, the system of the instant invention uses sensors to continuously calculate the distances to the nearest interior surface and corrects the position of said robot 2 within the duct.

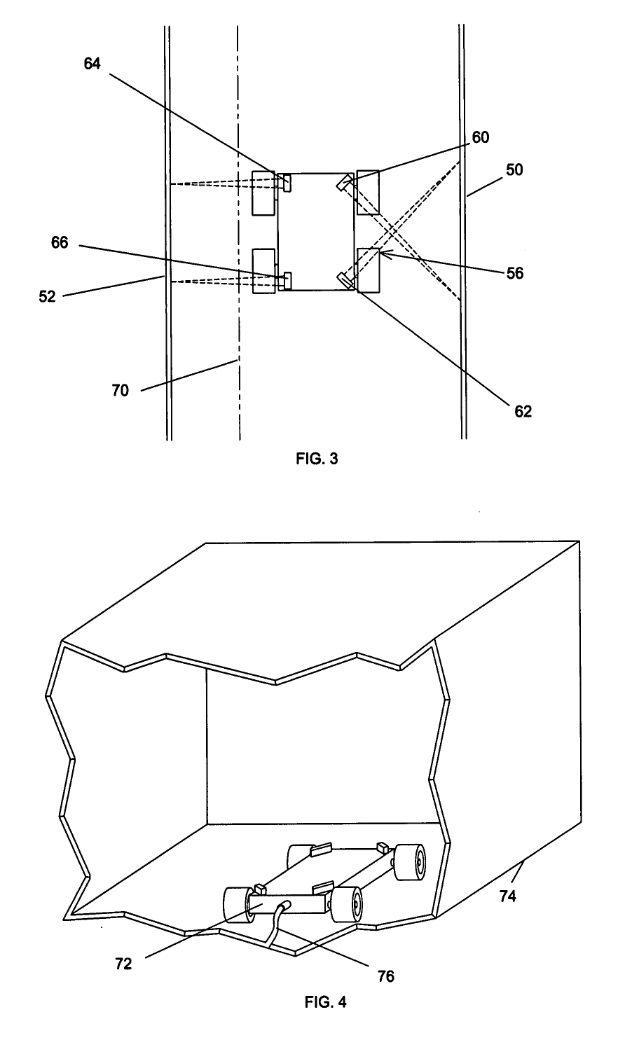

Referring now to FIG. 3, a top view of a second embodiment of the automatic self-centering duct robot of the instant invention is shown. This embodiment is intended to show that the instant invention could be modified in a variety of ways and still function within the spirit of the invention. In this embodiment duct side 50 is on the right side of a second robot 56 and a duct side 52 is on the left side. Rather than being directed forward and to the right as described above for said sensor 10, a sensor 60 points rearward and to the right at a forty-five degree angle to the duct side 50 and a sensor 62 points forward and to the right. Sensor 64 and sensor 66 are directed toward a duct side 52 at right angles to the longitudinal axis of the second robot 56 from the forward end and the rearward end of said second robot 56 respectively. It would be relatively simple to use the Pythagorean theorem and a microcontroller as described above to determine the position of said robot 56 using the distance measured using sensor 64 and sensor 60 when moving forward and using sensor 62 and sensor 66 when moving rearward. Various other configurations of sensors could be used to achieve the same result. This figure also shows an offset path 70 which may be offset from the centerline of the duct on either side. As described above, it would be relatively simple to control either said robot 2 or said second robot 56 such that they traveled along such an offset path 70. This would be useful if, for example, there was an attachment to the robot and it was preferable to have the attachment travel down the centerline with the robot off to one side.

Referring now to FIG. 4, an isometric view of the self-centering duct robot of the instant invention within a duct is shown. The robot 72 is shown as being inside a rectangular duct 74. In this view there may be seen that the robot 72 is connected to a tether 76. The operating system (not shown, but described above) is connected to the other end of the tether 76 and the signals controlling the motors described above also travel through said tether 76. Said tether 76 may also be used to recover said robot 72 from within the rectangular duct 74. In this figure said robot 72 may represent either said robot 2 or said second robot 56 as described above. Depending upon operator input through said tether 76, may be used to operate said robot 72 either forward or backward through said rectangular duct 74 either along the centerline of said rectangular duct 74 or along some offset to the centerline. The speed of said robot 72 through said rectangular duct 74 may be either preset or operator controlled in the event that video feedback is supplied in the form of a forward facing and a rearward facing camera affixed to said robot 72. In addition, a variety of cleaning or maintenance tools could easily be affixed to said robot 72.

All elements of the automatic self-centering duct robot are made of stainless steel and delren except for those described below, but other material having similar strength and stiffness could be used. Said platform 4 is specifically manufactured for the instant invention, but all other elements including wheels, axles, sensors, motor drivers, and the microcontroller are all conventional and easily obtained from a variety of sources.

While preferred embodiments of this invention have been shown and described above, it will be apparent to those skilled in the art that various modifications may be made in these embodiments without departing from the spirit of the present invention.

We claim:

1. An automatic self-centering robot intended to operate within a defined enclosed space such as a conduit or duct having a consistent cross section with forward describing movement in one direction through the defined enclosed space and movement in the other direction being described as rearward comprising:
(1) a platform with at least three attached rotatable wheels upon which the platform may move through the defined enclosed space;
(2) two controllable motors each having the capability of turning any two of the wheels in either direction and at variable speeds such that said platform may be moved within the defined enclosed space in any direction by controlling the speed and direction of rotation of the two controllable motors;
(3) at least two lateral distance sensors affixed to said platform and directed toward the sidewalls of the defined enclosed space such that, using data from the lateral distance sensors, the position of said platform relative to the sidewalls may continuously determined; and
(4) a microcontroller capable of determining the distance between said platform and the sidewalls using data from the lateral distance sensors and capable of controlling said two controllable motors such that said platform may be moved through the defined enclosed space in any direction and with any specified distance between either of the sidewalls and said platform;
whereby the automatic self-centering robot may be moved through a defined enclosed space such as a duct or conduit either forward or rearward in a predetermined path such as along the centerline of the defined enclosed space or along a path offset from the centerline.

2. The automatic self-centering robot of claim 1 in which a height sensor is affixed to said platform such that the height of the defined enclosed space may be determined.

3. The automatic self-centering robot of claim 1 in which the microcontroller may be programmed to move said platform automatically through the defined enclosed space, either forward or rearward, along any predetermined path.

4. The automatic self-centering robot of claim 1 in which an operator may use feedback from said microcontroller and control said controllable motors to manually move said platform through the defined enclosed space.

5. The automatic self-centering robot of claim 2 in which the microcontroller may be programmed to move said platform automatically through the defined enclosed space, either forward or rearward, along any predetermined path.

6. The automatic self-centering robot of claim 2 in which an operator may use feedback from said microcontroller and control said controllable motors to manually move said platform through the defined enclosed space.

7. An automatic self-centering robot intended to operate within a defined enclosed space such as a conduit or duct having a consistent cross section with forward describing movement in one direction through the defined enclosed space and movement in the other direction being described as rearward comprising:
(1) a platform with two rotatable belts upon which the platform may move through the defined enclosed space;
(2) two controllable motors each having the capability of turning one of the rotatable belts in either direction and at variable speeds such that said platform may be moved within the defined enclosed space in any direction by controlling the speed and direction of rotation of the two controllable motors;
(3) at least two lateral distance sensors affixed to said platform and directed toward the sidewalls of the defined enclosed space such that, using data from the lateral distance sensors, the position of said platform relative to the sidewalls may continuously determined; and
(4) a microcontroller capable of determining the distance between said platform and the sidewalls using data from the lateral distance sensors and capable of controlling said two controllable motors such that said platform may be moved through the defined enclosed space in any direction and with any specified distance between either of the sidewalls and said platform;
whereby the automatic self-centering robot may be moved through a defined enclosed space such as a duct or conduit either forward or rearward in a predetermined path such as along the centerline of the defined enclosed space or along a path offset from the centerline.

8. The automatic self-centering robot of claim 7 in which a height sensor is affixed to said platform such that the height of the defined enclosed space may be determined.
